(19) United States
(12) Patent Application Publication
(10) Pub. No.: US 2025/0218089 A1
(43) Pub. Date: Jul. 3, 2025

(54) RETARGETING CHARACTER ANIMATION BY TRANSFERRING SELF-AWARENESS

(71) Applicant: AUTODESK, INC., San Francisco, CA (US)

(72) Inventors: Andriy BANADYHA, Cambridge (GB); Alain BAUR, San Francisco, CA (US); Yves BOUDREAULT, San Francisco, CA (US); Mark Thomas DAVIS, Mill Valley, CA (US); Hans David KELLNER, Oakland, CA (US); Hilmar A. KOCH, San Francisco, CA (US)

(21) Appl. No.: 18/402,594

(22) Filed: Jan. 2, 2024

(51) Int. Cl. G06T 13/40

(52) U.S. Cl. CPC G06T 13/40

(57) ABSTRACT

One embodiment of the present invention sets forth a technique for retargeting character animation from a given actor model to a given avatar model. The technique includes receiving a set of correspondence relationships between one or more reference points in the actor model and one or more reference points in the avatar model, determining a misaligned reference point in the avatar model relative to the actor model, and identifying, based on the set of correspondence relationships, a reference point in the actor model corresponding to the misaligned reference point in the avatar model. The technique further includes calculating a distance vector between the identified reference point in the actor model and another reference point in the actor model and adjusting the location of the misaligned reference point in the avatar model based on the distance vector.

### BACKGROUND

### Field of the Various Embodiments

Embodiments of the present disclosure relate generally to computer graphics and computer animation and, more specifically, to techniques for performing character animation retargeting.

### Description of the Related Art

In the field of computer animation, character animation retargeting is the process of transferring motion from one hierarchy of items to another. A hierarchy of items may be, for example, an ordered arrangement of bones and/or joints in an animation character model.

One application of character animation retargeting is to transfer a motion sequence developed for one animation character model to another instance of the same animation character model, or to a different animation character model. In this manner, character animation retargeting allows for the reuse of motion sequences across a variety of animation character models, rather than having to separately develop the motion sequence for each animation character model.

Another application of character animation retargeting is to capture a live-action motion sequence from a live object, e.g., a human actor, and transfer the captured motion sequence to an animation character model that represents an avatar of the live object. The avatar may be placed into a variety of environments, such as a movie, TV show, video game, or video teleconferencing application.

Character animation retargeting presents challenges when a motion sequence that is developed or captured for one animation character model is transferred to an animation character model with significantly different bodily characteristics, such as bodily proportions. In particular, a motion sequence that results in a character's hand(s) being placed near to or in contact with the character's body may not produce a similar relationship between hand(s) and body in the animation model to which the motion sequence is transferred. For example, if a motion sequence that causes a character to place its hands on its cheeks is transferred to an animation character model that has a disproportionally larger head, the transferred motion may result in the hands intruding into the interior of the transferee character model's larger head. Similarly, if the transferee character model has a disproportionately smaller head, the same motion sequence may result in the character model's hands coming to rest at a distance from the character model's cheeks rather than in contact with the cheeks.

Proportionality differences may arise when transferring motion sequences from a human animation model to a non-human avatar such as an alien or fantasy creature, or to a human avatar with exaggerated body proportions. Even when transferring a motion sequence from a human animation model to a human avatar model of similar height, normal variations between humans in the lengths of corresponding body parts may cause misalignments as described above. Misalignments in transferred motion sequences must be corrected so that the transferred motion sequence produces the same relative positioning of body parts in the transferee model/avatar as in the model for which the motion sequence was developed or captured.

Existing character animation retargeting techniques may rely on manual correction of misalignments between body parts in an avatar model. In manual correction, a user must identify a misalignment, develop a corrected animation, and select one or more portions of the motion sequence to which to apply the corrected animation.

Existing techniques may also restrict motion sequences for retargeting to minimize the visual effects of misalignments between body parts. For instance, a human actor whose motions are being captured may be directed not to touch their face or body or to not eat or drink, to minimize instances in the captured motion sequence where body parts are brought into close proximity or contact with one another. A misalignment between avatar body parts that are separated by a significant distance in an animation sequence may require a minor correction or no correction at all compared to a misalignment between body parts that are supposed to be in contact or in close proximity with one another.

One drawback to the above techniques is that single motion sequence may require several corrected animations, and manual correction may require a different set of one or more corrected animations for each new transferee avatar or model. Further, manual correction is limited to the post-production environment and is not suitable for real-time adjustments to an avatar or model that is intended to reproduce live motion sequences captured from a human. As an example, manual correction is unsuitable in the case of an avatar intended to represent a human user's captured movements in a video teleconferencing application. Another drawback of the above techniques is that intentionally limiting the range of captured or developed motion sequences to minimize the effects of misalignments may cause the motion sequences to appear artificial or unnatural, as humans frequently touch their hand(s) to their face or body, or clasp/wring their hands together.

As the foregoing illustrates, what is needed in the art are more effective techniques for performing character animation retargeting.

### SUMMARY

One embodiment of the present invention sets forth a technique for retargeting character animation from a given actor model to a given avatar model. The technique includes receiving a set of correspondence relationships between one or more reference points in the actor model and one or more reference points in the avatar model, determining a misaligned reference point in the avatar model relative to the actor model, and identifying, based on the set of correspondence relationships, a reference point in the actor model corresponding to the misaligned reference point in the avatar model. The technique further includes calculating a distance vector between the identified reference point in the actor model and another reference point in the actor model and adjusting the location of the misaligned reference point in the avatar model based on the distance vector.

One technical advantage of the disclosed technique relative to the prior art is that the disclosed technique does not rely on manual correction of misalignments in retargeted motion sequences. As a result, the disclosed technique is suitable for real-time correction rather than being limited to only post-production correction. Another technical advantage of the disclosed technique is that it provides automatic correction for retargeted motion sequences that position character model body parts in proximity to or in contact with each other. This automatic correction allows for retargeting of a wider variety of motion sequences and the retargeting of more natural motion sequences, especially in models or avatars that are intended to reproduce human movements. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device 100 configured to implement one or more aspects of various embodiments.

FIGS. 2A and 2B depict an actor model 200 and an avatar model 205, respectively, according to various embodiments.

FIG. 3 is a more detailed illustration of retargeting engine 122 of FIG. 1, according to various embodiments.

FIG. 4 is a flow diagram of method steps for adjusting the position of a reference point in an avatar model, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

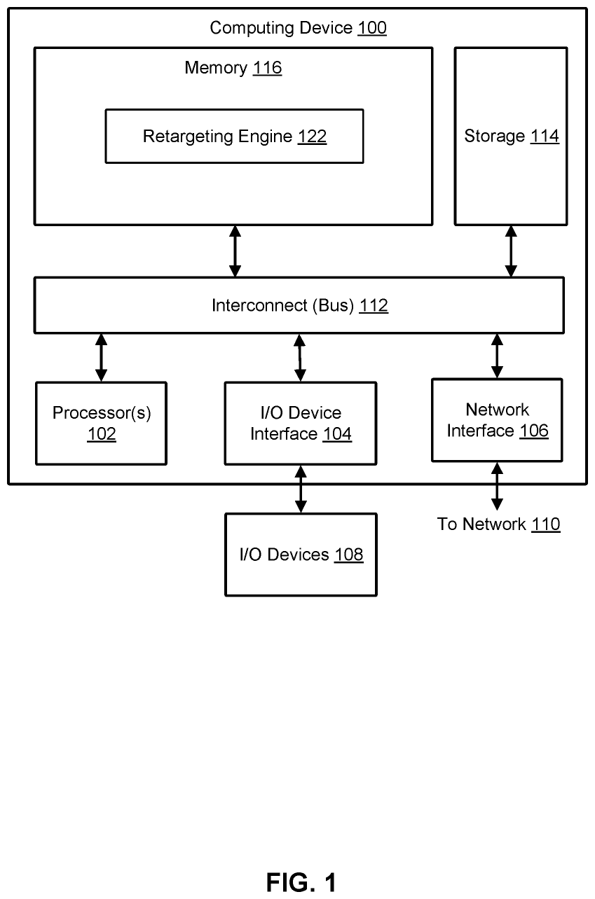

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a retargeting engine 122 that resides in a memory 116.

It is noted that the computing device described herein is illustrative and that any other technically feasible configurations fall within the scope of the present disclosure. For example, multiple instances of retargeting engine 122 could execute on a set of nodes in a distributed and/or cloud computing system to implement the functionality of computing device 100. In another example, retargeting engine 122 could execute on various sets of hardware, types of devices, or environments to adapt retargeting engine 122 to different use cases or applications. In a third example, retargeting engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including retargeting engine 122.

In character animation retargeting, retargeting engine 122 transfers a motion sequence from an actor model to an avatar model. More specifically, retargeting engine 122 adjusts the relative positions of reference points included in the avatar model to preserve positional relationships between specified reference points included in the actor model. In various embodiments, the actor model may perform a motion sequence developed for an animation character or a motion sequence captured from a human actor via an arrangement of cameras and/or sensors. In various embodiments, the instructions for implementing the features of the claimed invention may be stored in storage 114 and loaded into memory 116 for execution on processor(s) 102.

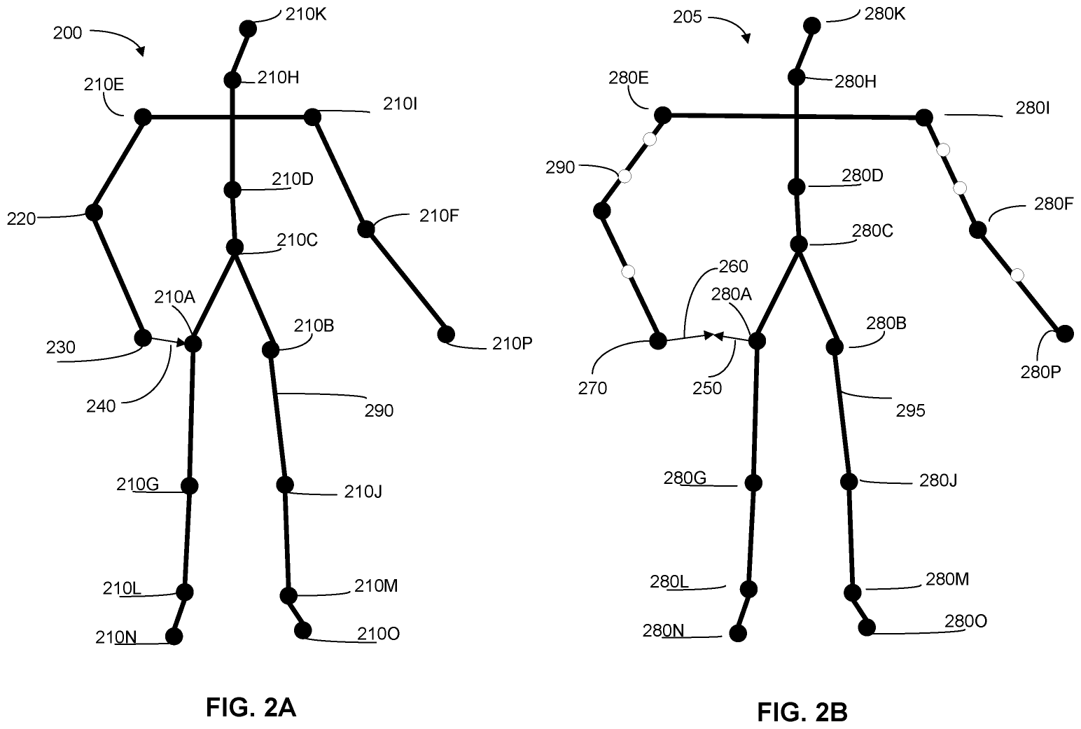

FIGS. 2A and 2B depict an actor model 200 and an avatar model 205, respectively, according to various embodiments. For example purposes, both actor model 200 and avatar model 205 are depicted facing outward such that reference point 230 represents the right wrist of actor model 200 and reference point 270 represents the right wrist of avatar model 205.

Actor model 200 and avatar model 205 may represent the positions of an actor and an avatar, respectively, during one frame of a multi-frame animation sequence. In various embodiments, the animation sequence includes motions of a human actor captured via one or more cameras and/or sensors that are subsequently transferred to the avatar model. Alternatively, the animation sequence may include digitally programmed motions of an animation character model that are subsequently transferred to the avatar model.

As shown in FIGS. 2A and 2B, each of actor model 200 and avatar model 205 includes one or more reference points, e.g., reference points 210A-O in actor model 200, reference points 280A-O in avatar model 205, and reference points 230 and 270. A reference point may represent a movable joint in the associated model, such as a knee or an elbow. Alternatively, a reference point may represent a specific fixed location on the associated model, such as a nose, ear, or mouth. Each reference point includes coordinates specifying a location of the reference point in a coordinate space, such as a three-dimensional coordinate space. Each of actor model 200 and avatar model 205 further includes one or more bones, e.g., reference points 290 and 295, with each bone representing a physical connection of a given length between two or more reference points. A bone defines a constraint on the relative positioning of its associated reference points and the position of the bone is determined by the locations of its associated reference points.

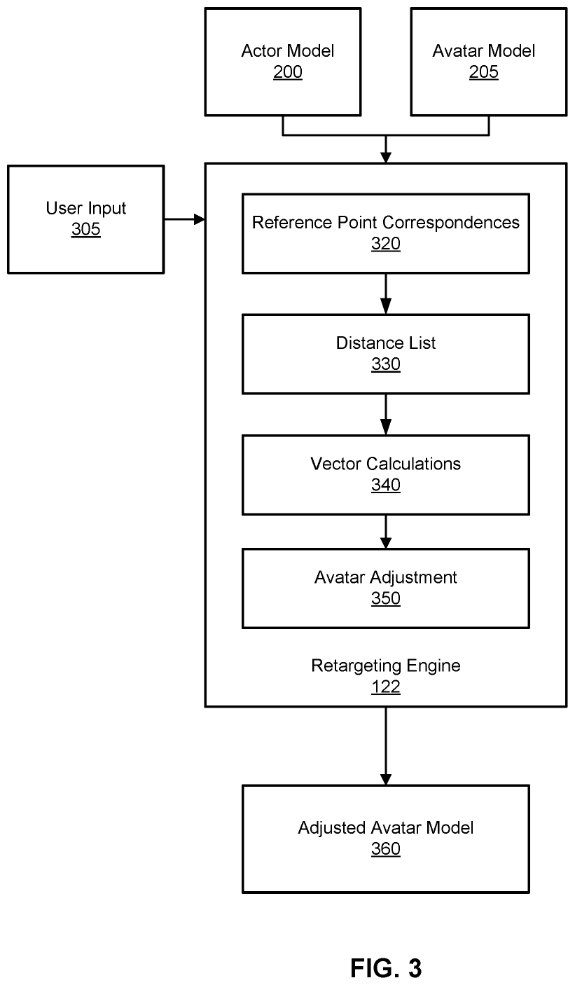

In various embodiments, a user or upstream software application may specify correspondence relationships between reference points on actor model 200 and avatar model 205, as discussed below in reference to FIG. 3. As an example, reference point 210A of actor model 200 may correspond to reference point 280A of avatar model 205. A reference point in either actor model 200 or avatar model 205 may not correspond to a reference point in the other model. For example, reference points FIG. 2B represented by open circles, e.g., reference point 290, may represent reference points in avatar model 205 that do not have corresponding reference points in actor model 200.

As shown in FIGS. 2A and 2B, the positioning of actor model 200 has been transferred to avatar model 205, resulting in avatar model 205 exhibiting similar posing as actor model 200. While avatar model 205, as shown in the example illustration of FIG. 2, shares many physical proportions with actor model 200, the shoulder width of avatar model 205 (i.e., the distance between reference points 280E and 280I) is greater than the shoulder width of actor model 200 (i.e., the distance between reference points 210E and 210I). This proportional difference between the two models results in a misalignment between reference points in avatar model 205 compared to the alignment between corresponding reference points in actor model 200. In particular, the distance between reference points 270 and 280A in avatar model 205 is proportionally greater than the distance between corresponding reference points 230 and 210A in actor model 200. Techniques for correcting such misalignments are discussed below in reference to FIG. 3.

FIG. 3 is a more detailed illustration of retargeting engine 122 of FIG. 1, according to various embodiments. Retargeting engine 122 receives an actor model 200, an avatar model 205, and user input 305 and generates an adjusted avatar model 360. As shown, retargeting engine 122 includes reference point correspondence 320, distance list 330, vector calculation 340, and avatar adjustment 350.

As described above in reference to FIG. 2, actor model 200 represents a given frame from an animated motion sequence for an actor. The animated motion sequence may be captured from the motions of a human actor or digitally programmed for an actor animation character model. Avatar model 205 is an animation character model representing motion transferred from actor model 200 for the frame of the animation sequence.

User input 305 includes a plurality of correspondence relationships between reference points in actor model 200 and avatar model 205. For example, reference point 210G in actor model 200 corresponds to reference point 280G in avatar model 205. Correspondence relationships may be specified by a human user on a Graphical User Interface (GUI), provided as a data file by an upstream software application, by a combination of the two methods, or by any technically feasible manner. Retargeting engine 122 generates reference point correspondences 320 based on the plurality of correspondence relationships included in user input 305.

User input 305 may include a designation by a human user or an upstream software application of one or more misaligned reference points on the avatar model. For example, user input 305 may include a designation that reference point 270 (i.e., the avatar model's right wrist) is misaligned. Retargeting engine 122 may also automatically determine one or more misaligned reference points based on corresponding reference points in actor model 200 and avatar model 205. User input 305 may also include dimensional measurements associated with actor model 200, such as a hand length for the actor model measured from a wrist reference point to the end of the longest finger on the corresponding hand. In various embodiments, user input 305 may also include personal space distance values for one or more reference points included in avatar model 205.

Based on reference point correspondences 320, retargeting engine 122 identifies a reference point on actor model 200 corresponding to the designated misaligned reference point in avatar model 205. Retargeting engine 122 generates distance list 330 that includes a calculated distance between the identified reference point on actor model 200 and each of a plurality of other reference points on actor model 200. In various embodiments, retargeting engine 122 records the calculated distances and reference points in distance list 330 in order from shortest distance to longest distance.

Referring back to FIG. 2, if user input 305 designates reference point 270 in avatar model 205 as being misaligned or retargeting engine 122 automatically determines that reference point 270 in avatar model 205 is misaligned, retargeting engine 122 may identify reference point 230 as the corresponding actor model reference point based on reference point correspondences 320. Retargeting engine 122 calculates distances between reference point 230 and one or more other reference points in actor model 200, e.g., reference points 210A-O, based on the three-dimensional coordinates of the reference points. For example, if the distance between reference point 230 and reference point 210A is the shortest calculated distance, retargeting engine 122 stores reference point 210A and the associated calculated distance as the first entry in distance list 330. Similarly, if the distance between reference point 230 and reference point 210B is the second-shortest calculated distance, retargeting engine 122 stores reference point 210B and the associated calculated distance as the second entry in distance list 330.

In various embodiments, retargeting engine 122 may omit one or more reference points in actor model 200 when calculating distances to be included in distance list 330. For instance, retargeting engine 122 may determine, based on constraints imposed by the bones and reference points in actor model 200, that a distance between reference point 230 (the actor model's right wrist) and reference point 220 (the actor model's right elbow) is physically constrained to always be greater than a length of the actor model's right hand measured from the right wrist to the tip of the longest finger on the right hand. Retargeting engine 122 may measure the hand length based on the reference points on actor model 200 or receive the measured hand length in user input 305. Based on this determination, retargeting engine 122 may omit reference point 220 from distance list 330 as not being useful for subsequent avatar model adjustments as described below.

Retargeting engine 122 performs vector calculations 340 based on the misaligned reference point in avatar model 205 designated in user input 305 and the entries in distance list 330. From the previous example, retargeting engine 122 identifies reference point 230 on actor model 200 as corresponding to misaligned reference point 270 on avatar model 205, and further identifies reference point 210A on actor model 200 as the closest reference point to reference point 230 based on distance list 330. Retargeting engine 122 calculates a vector Vo (drawing element 240) from reference point 230 to closest reference point 210A representing a direction and distance from reference point 230 to reference point 210A.

As discussed above, misaligned reference points in avatar model 205 are often more noticeable when one body part is close to or touching another body part in actor model 200 (e.g., a hand on a hip or a hand touching the mouth). Retargeting engine 122 adjusts the length of vector Vo based on the calculated distance values in distance list 330 by defining a precise zone and a transition zone. The precise zone and the transition zone are based on dimensions of the actor model. In various embodiments, the precise zone is distance equal to a length of a given portion of actor model 200, wherein the length may be calculated from actor model 200 or included in user input 305. In various embodiments, the transition zone is a distance that extends beyond the precise zone by a distance equal to the distance between two other portions of actor model 200 proximal to the given portion. For example, the precise zone may be a distance equal to a hand length for actor model 200, wherein the hand length may be calculated from actor model 200 or included in user input 305. As another example, the transition zone may be a distance that extends beyond the precise zone by a distance equal to the distance between the wrist and elbow reference points in actor model 200.

If the shortest distance in distance list 330 is less than or equal to the precise zone, then retargeting engine 122 does not adjust the length of vector Vo. Retargeting engine 122 reverses the direction of Vo to generate vector 250 and places the tail of vector 250 at the reference point in avatar model 205 corresponding to the closest actor model reference point in distance list 330. With vector 250 placed in this manner, the head of vector 250 represents an adjusted location for the misaligned reference point in avatar model 205. Retargeting engine 122 calculates an adjustment vector 260 from the misaligned reference point to the adjusted location.

If the shortest distance in distance list 330 is greater than the transition zone, retargeting engine 122 assigns a value of zero to adjustment vector 260 and does not adjust the location of the misaligned reference point in avatar model 205. Because the distance from the actor model reference point corresponding to the misaligned avatar model reference point to the closest other reference point in actor model 200 is larger than the transition zone, the misalignment of the avatar model reference point is not likely to be noticeable in the avatar character animation.

If the shortest distance in distance list 330 is greater than the precise zone and less than or equal to the transition zone, retargeting engine 122 adjusts the length of Vo using, e.g., a linear or logarithmic scaling factor, such that the length of adjustment vector 260 approaches zero for values of the shortest distance in distance list 330 closer to the transition zone distance.

Retargeting engine 122 applies adjustment vector 260 to the misaligned reference point to reposition the misaligned reference point to the adjusted location. If the adjusted location would place the misaligned reference point in the middle of a bone included in the avatar model, retargeting engine 122 may multiply Vo by a ratio R associated with actor model 200 and avatar model 205. Retargeting engine 122 recalculates a new adjustment vector 260 based on the multiplied value of Vo and repositions the misaligned reference point based on new adjustment vector 260. In various embodiments, the ratio R is calculated by dividing the distance between the two reference points in avatar model 205 closest to the misaligned reference point by the distance between the two corresponding reference points in actor model 200.

In various embodiments where user input 305 includes personal space distance values for one or more reference points in avatar model 205, retargeting engine 122 may further modify the adjusted location of the misaligned reference point based on the personal space distance values. A personal space distance value associated with a reference point represents a minimum allowable distance between the reference point and an adjusted location for a misaligned reference point. Retargeting engine 122 may adjust Vo to maintain this minimal allowable distance when adjusting the location of the misaligned reference point.

Retargeting engine 122 generates and stores adjusted avatar model 360. Retargeting engine may subsequently perform further adjustments to avatar model 205 such as adjusting the position of one or more additional misaligned reference points. In various embodiments, retargeting engine 122 may adjust multiple misaligned reference points sequentially or concurrently based on user input 305. For instance, user input 305 may designate a left hand, a right hand, or both hands for adjustment.

Retargeting engine 122 may further process additional instances of actor model 200 and avatar model 205 representing additional frames of an animated motion sequence. Retargeting engine 122 may continue processing additional instances of actor model 200 and avatar model 205 until retargeting engine 122 has adjusted all instances of avatar model 205 in the animated motion sequence.

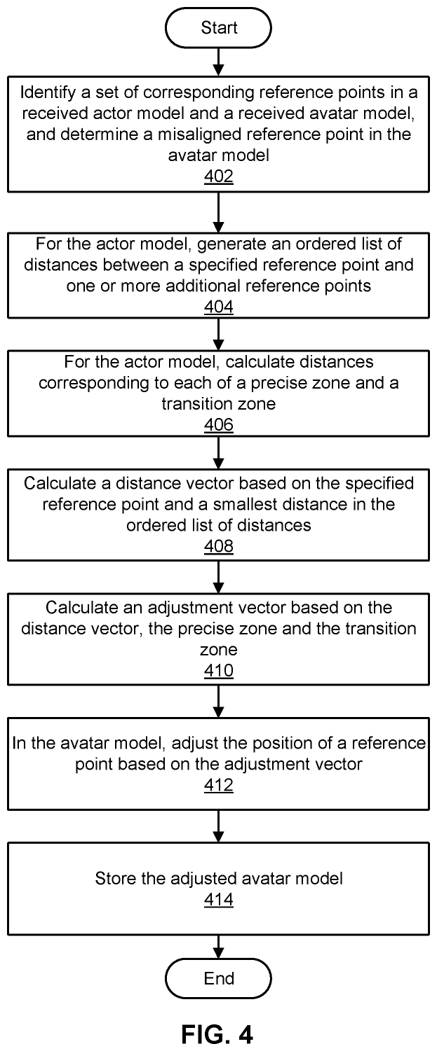

FIG. 4 is a flow diagram of method steps for adjusting the position of a reference point in an avatar model, according to various embodiments. Although the method steps are described in conjunction with the systems of FIGS. 1 and 2, persons skilled in the art will understand that any system configured to perform the method steps in any order falls within the scope of the present disclosure.

As shown, in operation 402, retargeting engine 122 receives an actor model and an avatar model. Retargeting engine 122 identifies correspondences between reference points in the actor model and reference points in the avatar model based on user input. Retargeting engine 122 also determines, either automatically or based on user input, a designation for one or more misaligned reference points in the avatar model and determines corresponding reference points in the actor model. Retargeting engine 122 may also receive a distance measurement associated with the actor model such as a hand length for the actor model.

In operation 404, retargeting engine 122 generates an ordered list of distances between a reference point in the actor model corresponding to a misaligned reference point in the avatar model and one or more other reference points in the actor model. Each entry in the ordered list of distances includes a distance, an identification of the other reference point, and a distance vector from the reference point in the actor model corresponding to a misaligned reference point in the avatar model and the other reference point in the actor model. The first entry in the ordered list of distances represents the shortest distance between the reference point in the actor model corresponding to a misaligned reference point in the avatar model and another reference point in the actor model.

In operation 406, retargeting engine 122 calculates distances corresponding to each of a precise zone and a transition zone based on the actor model. In various embodiments, the precise zone is distance equal to a length of a given portion of actor model 200, wherein the length may be calculated from actor model 200 or included in user input 305. In various embodiments, the transition zone is a distance that extends beyond the precise zone by a distance equal to the distance between two other portions of the actor model 200 proximal to the given portion. For example, the precise zone may be equal to a hand length for the actor model, and the transition zone may be equal to the precise zone plus an additional distance equal to a distance between reference points on the actor model representing a wrist and a corresponding elbow, e.g., a right wrist and a right elbow.

In operation 408, retargeting engine 122 calculates a distance vector based on the reference point in the actor model corresponding to a misaligned reference point in the avatar model and the closest other reference point in the actor model. As discussed above, retargeting engine 122 may retrieve the distance vector from the first entry in the ordered list of distances.

In operation 410, retargeting engine 122 calculates an adjustment vector for the misaligned reference point in the avatar model. If the length of the distance vector calculated above in operation 408 is greater than the transition zone calculated in operation 406, retargeting engine 122 sets the length of the adjustment vector equal to zero. If the length of the distance vector is less than or equal to the precise zone, retargeting engine 122 calculates the adjustment vector such that the positional relationship between the misaligned reference point in the avatar model and the closest other reference point in the avatar model is equal to the positional relationship between the corresponding reference points in the actor model. If the distance vector is greater than the precise zone and less than or equal to the transition zone, retargeting engine 122 calculates the adjustment vector such that larger magnitude distance vector values result in smaller magnitude adjustment vectors and vice versa.

In operation 412, retargeting engine 122 adjusts the position of the misaligned reference point in the avatar model based on the adjustment vector. In various embodiments, retargeting engine 122 may apply further adjustments to the misaligned reference point. For example, retargeting engine 122 may calculate and apply a further adjustment if the adjusted position of the misaligned reference point lies on a bone of the avatar model. Retargeting engine 122 may also calculate and apply a further adjustment if the adjusted position of the misaligned reference point is closer than a minimum specified personal space distance from another reference point in the avatar model.

In operation 414, retargeting engine 122 stores the adjusted avatar model. In various embodiments, retargeting engine 122 may perform multiple adjustments to an avatar model sequentially or concurrently. For example, retargeting engine 122 may calculate and apply adjustments to a left hand of an avatar model followed by adjustments to a right hand of the avatar model, or retargeting engine 122 may calculate and apply adjustments to both hand simultaneously. Retargeting engine 122 may further calculate and apply adjustments to additional instances of an actor model and an avatar model representing additional frames of an animation motion sequence.

In sum, the disclosed techniques process an actor model and an avatar model to transfer a motion sequence from the actor model to the avatar model. When transferring the motion sequence to the avatar model, the disclosed techniques maintain positional relationships between various reference points included in the avatar model based on positional relationships between corresponding reference points included in the actor model. For instance, the disclosed techniques may adjust one or more reference points of the avatar model to maintain a positional relationship in the avatar model between e.g. a hand and a hip based on a corresponding positional relationship in the actor model.

A retargeting engine receives an actor model and an avatar model. The actor model and the avatar model may represent the positioning of an actor and an avatar as depicted in a single frame of a motion sequence. The actor may be a human actor whose motions have been captured via one or more cameras and/or sensors, or the actor may be a previously created animation character model. The actor and avatar models each include multiple reference points, and each reference point may represent a movable joint in the model such as a knee or elbow. The actor and avatar models may each include connections between reference points representing bones that define physical relationships between reference points. A reference point may also represent a specific fixed location on a model, such as a nose, ear, or eye. The actor model and the avatar model may not include the same number of reference points. For instance, an avatar model may include additional limb joints compared to an actor model.

While the positioning of the avatar model may generally reflect the positioning of the actor model, proportional differences between the actor and avatar models may cause misalignments in the positioning of the avatar model. For instance, if the avatar model has a proportionally larger shoulder width compared to the actor model, a hand included in the actor model may be in contact with a hip included in the actor model, while the corresponding hand and hip in the avatar model may be separated by a significant distance. The retargeting engine adjusts portions of the avatar model to correct misalignments in the avatar model when specified portions of the actor model are in contact with or in close proximity with one another.

In operation, the retargeting engine receives user input denoting one-to-one correspondence relationships between pairs of reference points in the actor model and the avatar model. The retargeting engine further receives user input identifying a reference point that requires adjustment in the avatar model to correct a misalignment. For example, the user may identify a misalignment in the avatar model's right hand and select the reference point “right hand” for adjustment. The retargeting engine may also receive dimensional data associated with the actor and/or avatar models such as a length of the actor models hand, or a personal space distance value for one or more reference points in the avatar model.

The retargeting engine generates an ordered list of distances in the actor model between the selected reference point and one or more other reference points in the actor model. The list is ordered such that the reference point closest to the selected reference point appears first in the list. The retargeting engine adjusts the selected reference point in the avatar model based on a distance between the selected reference point in the actor model and the closest other reference point in the actor model, i.e., the first entry in the ordered list of distances.

More specifically, the retargeting engine calculates a vector from the selected reference point in the actor model to the nearest other reference point in the actor model. A vector of equal length and opposite direction is applied to the reference point in the avatar model corresponding to the nearest other reference point in the actor model to determine the adjusted position for the selected reference point in the avatar model. The retargeting engine calculates a vector from the selected reference point in the avatar model to the adjusted position and applies an adjustment based on the vector to place the selected reference point in the avatar model in the adjusted position.

Adjustments to the selected reference point in the avatar model often need to be more precise when the selected reference point in the actor model is in contact with or in close proximity to the nearest other reference point in the actor model. For example, if a hand is touching a hip in the actor model, this same spatial relationship should be reflected in the adjusted avatar model. In these scenarios, the retargeting engine calculates a precise zone distance based on dimensions of the actor model, e.g., a hand length. The retargeting engine also calculates a larger transition zone distance based on, e.g. a distance between an elbow and a wrist in the actor model. The magnitude of an adjustment applied to the avatar is scaled depending on the distance between the selected reference point and the nearest other reference point in the actor model. If the distance between the selected reference point and the nearest other reference point in the actor model is greater than the transition zone distance, then no adjustment is applied to the avatar model.

The above techniques may be repeated for one or more frames of the captured or generated motion sequence, or an adjustment determined for one frame may be applied directly to another frame. Further, the techniques may be repeated with one or more additional selected reference points, e.g., a left hand, a right hand, or both hands, with the adjustments being calculated simultaneously or sequentially.

One technical advantage of the disclosed technique relative to the prior art is that the disclosed technique does not rely on manual correction of misalignments in retargeted motion sequences. As a result, the disclosed technique is suitable for real-time correction rather than being limited to only post-production correction. Another technical advantage of the disclosed technique is that it provides automatic correction for retargeted motion sequences that position character model body parts in proximity to or in contact with each other. This automatic correction allows for retargeting of a wider variety of motion sequences and the retargeting of more natural motion sequences, especially in models or avatars that are intended to reproduce human movements.

1. In some embodiments, a computer-implemented method of retargeting animation in an avatar model comprises receiving, for an actor model and an avatar model, a set of correspondence relationships between one or more reference points in the actor model and one or more reference points in the avatar model, determining a misaligned reference point in the avatar model relative to the actor model, identifying, based on the set of correspondence relationships, a reference point in the actor model corresponding to the misaligned reference point in the avatar model, calculating a distance vector between the identified reference point in the actor model and another reference point in the actor model, and adjusting the location of the misaligned reference point in the avatar model based on the distance vector.

2. The computer-implemented method of clause 1, further comprising calculating, based on one or more dimensions of the actor model, a distance value corresponding to a precise zone and a distance value corresponding to a transition zone.

3. The computer-implemented method of clauses 1 or 2, further comprising modifying the location of the misaligned reference point based on the distance vector, the distance value corresponding to the precise zone, and the distance value corresponding to the transition zone.

4. The computer-implemented method of any of clauses 1-3, further comprising determining that a magnitude of the distance vector is greater than the distance value corresponding to the transition zone, and removing an adjustment to the location of the misaligned reference point based on the determination that the magnitude of the distance vector is greater than the distance value corresponding to the transition zone.

5. The computer-implemented method of any of clauses 1-4, further comprising generating an ordered list of distances between the identified reference point in the actor model and one or more other reference points in the actor model.

6. The computer-implemented method of any of clauses 1-5, wherein a first entry in the ordered list of distances includes a distance and a direction from the identified reference point in the actor model to the closest other reference point in the actor model.

7. The computer-implemented method of any of clauses 1-6, wherein the method further comprises receiving, for one or more of the reference points in the avatar model, an associated personal space distance value, and adjusting the location of the misaligned reference point in the avatar model such that a distance between the misaligned reference point and a reference point in the avatar model is not less than the personal space distance value associated with the reference point.

8. The computer-implemented method of any of clauses 1-7, wherein each of the actor model and the avatar model are associated with a single frame of an animated motion sequence having a plurality of frames.

9. The computer-implemented method of any of clauses 1-8, wherein the relative positions of the one or more reference points in the actor model are based on one of the positioning of a live object or a programmed character animation sequence.

10. In some embodiments, one or more non-transitory computer-readable media store instructions that, when executed by one or more processors, cause the one or more processors to perform the steps of receiving, for an actor model and an avatar model, a set of correspondence relationships between one or more reference points in the actor model and one or more reference points in the avatar model, determining a misaligned reference point in the avatar model relative to the actor model, identifying, based on the set of correspondence relationships, a reference point in the actor model corresponding to the misaligned reference point in the avatar model, calculating a distance vector between the identified reference point in the actor model and another reference point in the actor model, and adjusting the location of the misaligned reference point in the avatar model based on the distance vector.

11. The one or more non-transitory computer-readable media of clause 10, wherein the instructions further cause the device to perform the steps of calculating, based on one or more dimensions of the actor model, a distance value corresponding to a precise zone and a distance value corresponding to a transition zone.

12. The one or more non-transitory computer-readable media of clauses 10 or 11, wherein the instructions further cause the device to perform the steps of modifying the location of the misaligned reference point based on the distance vector, the distance value corresponding to the precise zone, and the distance value corresponding to the transition zone.

13. The one or more non-transitory computer-readable media of any of clauses 10-12, wherein the instructions further cause the device to perform the steps of determining that a magnitude of the distance vector is greater than the distance value corresponding to the transition zone, and removing an adjustment to the location of the misaligned reference point based on the determination that the magnitude of the distance vector is greater than the distance value corresponding to the transition zone.

14. The one or more non-transitory computer-readable media of any of clauses 10-13, wherein the instructions further cause the device to perform the steps of generating an ordered list of distances between the identified reference point in the actor model and one or more other reference points in the actor model.

15. The one or more non-transitory computer-readable media of any of clauses 10-14, wherein a first entry in the ordered list of distances includes a distance and a direction from the identified reference point in the actor model to the closest other reference point in the actor model.

16. The one or more non-transitory computer-readable media of any of clauses 10-15, wherein the method further comprises receiving, for one or more of the reference points in the avatar model, an associated personal space distance value, and adjusting the location of the misaligned reference point in the avatar model such that a distance between the misaligned reference point and a reference point in the avatar model is not less than the personal space distance value associated with the reference point.

17. The one or more non-transitory computer-readable media of any of clauses 10-16, wherein each of the actor model and the avatar model are associated with a single frame of an animated motion sequence having a plurality of frames.

18. The one or more non-transitory computer-readable media of any of clauses 10-17, wherein the relative positions of the one or more reference points in the actor model are based on one of the positioning of a live object or a programmed character animation sequence.

19. In some embodiments, a system comprises one or more memories storing instructions, and one or more processors for executing the instructions to receive, for an actor model and an avatar model, a set of correspondence relationships between one or more reference points in the actor model and one or more reference points in the avatar model, determine a misaligned reference point in the avatar model relative to the actor model, identify, based on the set of correspondence relationships, a reference point in the actor model corresponding to the misaligned reference point in the avatar model, calculate a distance vector between the identified reference point in the actor model and another reference point in the actor model, and adjust the location of the misaligned reference point in the avatar model based on the distance vector.

20. The system of clause 19, wherein the one or more processors further execute the instruction to receive, for one or more of the reference points in the avatar model, an associated personal space distance value, and adjust the location of the misaligned reference point in the avatar model such that a distance between the misaligned reference point and a reference point in the avatar model is not less than the personal space distance value associated with the reference point. Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method of retargeting animation in an avatar model, the computer-implemented method comprising:
receiving, for an actor model and an avatar model, a set of correspondence relationships between one or more reference points in the actor model and one or more reference points in the avatar model;
determining a misaligned reference point in the avatar model relative to the actor model;
identifying, based on the set of correspondence relationships, a reference point in the actor model corresponding to the misaligned reference point in the avatar model;
calculating a distance vector between the identified reference point in the actor model and another reference point in the actor model; and
adjusting a location of the misaligned reference point in the avatar model based on the distance vector.

2. The computer-implemented method of claim 1, further comprising calculating, based on one or more dimensions of the actor model, a distance value corresponding to a precise zone and a distance value corresponding to a transition zone.

3. The computer-implemented method of claim 2, further comprising modifying the location of the misaligned reference point based on the distance vector, the distance value corresponding to the precise zone, and the distance value corresponding to the transition zone.

4. The computer-implemented method of claim 3, further comprising:
determining that a magnitude of the distance vector is greater than the distance value corresponding to the transition zone; and
removing an adjustment to the location of the misaligned reference point based on the determination that the magnitude of the distance vector is greater than the distance value corresponding to the transition zone.

5. The computer-implemented method of claim 1, further comprising generating an ordered list of distances between the identified reference point in the actor model and one or more other reference points in the actor model.

6. The computer-implemented method of claim 5, wherein a first entry in the ordered list of distances includes a distance and a direction from the identified reference point in the actor model to the closest other reference point in the actor model.

7. The computer-implemented method of claim 1, wherein the method further comprises:
receiving, for one or more of the reference points in the avatar model, an associated personal space distance value; and
adjusting the location of the misaligned reference point in the avatar model such that a distance between the misaligned reference point and a reference point in the avatar model is not less than the personal space distance value associated with the reference point.

8. The computer-implemented method of claim 1, wherein each of the actor model and the avatar model are associated with a single frame of an animated motion sequence having a plurality of frames.

9. The computer-implemented method of claim 1, wherein relative positions of the one or more reference points in the actor model are based on one of the positioning of a live object or a programmed character animation sequence.

10. One or more non-transitory computer-readable media storing instructions that, when executed by one or more processors, cause the one or more processors to perform the steps of:
receiving, for an actor model and an avatar model, a set of correspondence relationships between one or more reference points in the actor model and one or more reference points in the avatar model;
determining a misaligned reference point in the avatar model relative to the actor model;
identifying, based on the set of correspondence relationships, a reference point in the actor model corresponding to the misaligned reference point in the avatar model;
calculating a distance vector between the identified reference point in the actor model and another reference point in the actor model; and
adjusting a location of the misaligned reference point in the avatar model based on the distance vector.

11. The one or more non-transitory computer-readable media of claim 10, wherein the instructions further cause the one or more processors to perform the steps of calculating, based on one or more dimensions of the actor model, a distance value corresponding to a precise zone and a distance value corresponding to a transition zone.

12. The one or more non-transitory computer-readable media of claim 11, wherein the instructions further cause the one or more processors to perform the steps of modifying the location of the misaligned reference point based on the distance vector, the distance value corresponding to the precise zone, and the distance value corresponding to the transition zone.

13. The one or more non-transitory computer-readable media of claim 12, wherein the instructions further cause the one or more processors to perform the steps of:
determining that a magnitude of the distance vector is greater than the distance value corresponding to the transition zone; and
removing an adjustment to the location of the misaligned reference point based on the determination that the magnitude of the distance vector is greater than the distance value corresponding to the transition zone.

14. The one or more non-transitory computer-readable media of claim 10, wherein the instructions further cause the one or more processors to perform the steps of:
generating an ordered list of distances between the identified reference point in the actor model and one or more other reference points in the actor model.

15. The one or more non-transitory computer-readable media of claim 14, wherein a first entry in the ordered list of distances includes a distance and a direction from the identified reference point in the actor model to the closest other reference point in the actor model.

16. The one or more non-transitory computer-readable media of claim 10, wherein the instructions further cause the one or more processors to perform the steps of:
receiving, for one or more of the reference points in the avatar model, an associated personal space distance value; and
adjusting the location of the misaligned reference point in the avatar model such that a distance between the misaligned reference point and a reference point in the avatar model is not less than the personal space distance value associated with the reference point.

17. The one or more non-transitory computer-readable media of claim 10, wherein each of the actor model and the avatar model are associated with a single frame of an animated motion sequence having a plurality of frames.

18. The one or more non-transitory computer-readable media of claim 10, wherein relative positions of the one or more reference points in the actor model are based on one of the positioning of a live object or a programmed character animation sequence.

19. A system comprising:
one or more memories storing instructions; and
one or more processors for executing the instructions to:
receive, for an actor model and an avatar model, a set of correspondence relationships between one or more reference points in the actor model and one or more reference points in the avatar model;
determine a misaligned reference point in the avatar model relative to the actor model;
identify, based on the set of correspondence relationships, a reference point in the actor model corresponding to the misaligned reference point in the avatar model;
calculate a distance vector between the identified reference point in the actor model and another reference point in the actor model; and
adjust the location of the misaligned reference point in the avatar model based on the distance vector.

20. The system of claim 19, wherein the one or more processors further execute the instruction to:
receive, for one or more of the reference points in the avatar model, an associated personal space distance value; and
adjust the location of the misaligned reference point in the avatar model such that a distance between the misaligned reference point and a reference point in the avatar model is not less than the personal space distance value associated with the reference point.
